(19) United States
(12) Patent Application Publication
(10) Pub. No.: US 2012/0104637 A1
(43) Pub. Date: May 3, 2012

(54) METHOD FOR PRODUCING OBJECTS WITH A DEFINED STRUCTURED SURFACE

(75) Inventors: Ullrich Daehnert, Lengefeld (DE); Juergen Schwarz, Apolda (DE); Stephan Otte, Jena (DE)

(73) Assignees: 3D INTERNATIONAL EUROPE GMBH, Jena (DE); SECCO GMBH, Lengefeld (DE)

(21) Appl. No.: 13/319,310

(22) PCT Filed: Apr. 16, 2010
(86) PCT No.: PCT/EP2010/055051

§ 371 Date: Jan. 17, 2012

(30) Foreign Application Priority Data
May 5, 2009 (DE) 102009019762.1

(51) Int. Cl. G02B 1/12; B29D 11/00

(52) U.S. Cl. 264/1.38; 264/1.1

(57) ABSTRACT

The invention relates to a method for fabricating objects with a structured optically effective surface for fabricating lenticular screens. The method may comprise:

applying a liquid plastic layer, consisting of a plastic that will cure by the input of energy, onto a substrate,

smoothing the surface of the liquid plastic layer,

inputting energy into the plastic, wherein

the amount of energy to be applied per unit of time is specified for different positions as a function of the structure height to be produced in these positions, so that, as a result of the energy input, different quantities of still uncured and already cured solidified plastic exist in different positions of the surface, and removing the uncured plastic whereby the remaining, cured plastic defines an optically effective structure.

### PRIORITY CLAIM

The present application is a National Phase entry of PCT Application No. PCT/EP2010/055051, filed Apr. 16, 2010, which claims priority from German Application Number 102009019762.1, filed May 5, 2009, the disclosures of which are hereby incorporated by reference herein in their entirety.

### FIELD OF THE INVENTION

The invention relates to a method for fabricating objects with a preferably optically effective surface structure that has, in different positions, differently specified structure heights, especially a method for fabricating lenticular screens.

### BACKGROUND OF THE INVENTION

Lenticular screens, also known as lens arrays, lenticulars or lenticular sheets, permit a viewer to have an impression of space in the 3D display of images without needing visual aids such as 3D glasses so far required in other kinds of 3D display. In this connection, computer monitors have become known in recent years that, if combined with lenticular screens, make it possible to see displayed images in three dimensions and in good imaging quality without further aids such as 3D glasses.

The growing success of 3D display of digital imagery on this basis increasingly adds to the importance of lenticular screens. The presently available products of this kind are relatively expensive, as the technology for providing the surface of the sheets with the optically effective structure is comparably costly, which hinders projection screens that permit three-dimensional viewing from gaining widespread use faster.

At present, optically effective surface structures in the form of lenses or prisms are fabricated either by direct methods, i.e. by scoring with diamond tools, or indirectly by molding with molds made of nickel alloys, the molds, though, having to be manufactured first by conventional processes.

Apart from the disadvantage of cost-intensive fabrication, another disadvantage is that present manufacturing methods cannot satisfy the requirement for increasingly finer and smaller structures, because the potential of these methods to reduce tool sizes is limited. Finer (smaller) structures are, however, necessary for improving the quality of the 3D display of moving pictures.

### SUMMARY OF THE INVENTION

The invention provides a method for the comparably lower-cost fabrication of lenticular screens.

According to an embodiment of the invention, that method comprises applying of a—still liquid—plastic layer, consisting of a plastic that will cure by the input of energy, onto a substrate; inputting of energy into the plastic, wherein the amount of energy to be applied per unit of time is specified for different positions as a function of the structure height to be produced in these positions, so that, as a result of the energy input, different quantities of still uncured and already cured plastic exist in different positions of the surface; and removing the uncured plastic, and the surface of the remaining, cured plastic defines the structure.

Herein “structure height” means the height of the plastic layer above the substrate in any positions of the structured surface.

An embodiment of the invention, suitable for the fabrication of optical elements, especially of lenticular screens, comprises applying of a curable, optically transparent plastic onto a substrate, smoothing the surface of the plastic layer, inputting of energy into the plastic layer, so that as a result of the energy input, the smallest quantities of still liquid plastic remain in positions with the greatest structure heights desired, and the greatest quantities of still liquid plastic remain in positions with the smallest structure heights desired, and removing the uncured plastic, so that the optically effective surface structure remains on the cured plastic, and joining the substrate with the cured plastic forming the optical element.

Another embodiment of the invention, likewise suitable for the fabrication of optical elements, especially of lenticular screens, comprises the following steps:

applying of a curable plastic onto a substrate,

smoothing the surface of the plastic layer,

inputting of energy into the plastic layer, so that

as a result of the energy input, the smallest quantities of still liquid plastic remain in positions with the smallest structure heights desired, and the greatest quantities of still liquid plastic remain in positions with the greatest structure heights desired, and

removing the uncured plastic, whereas the cured plastic remains as a negative profile of the optically effective surface structure,

topping the negative profile with a curable, optically transparent plastic,

curing the optically transparent plastic by the action of energy and thereafter removing from the negative profile, thus forming the optical element.

Advantageously, a separating layer may be applied onto the negative profile before the topping-up. This is achieved, for example, by applying a thin plastic foil or by sputtering or vapor-depositing a film of plastic or metal onto the negative profile.

In another preferred embodiment, the cured plastic, either before or after its separation from the negative profile, is joined with the surface of a substrate and thus stabilized. This is recommendable especially if the plastic layer is very thin.

In various embodiments, such as outlined above, the energy input can be effected
with a laser beam guided in a scanning manner over the surface to be structured, with the energy quantity to be applied being varied with the radiation intensity, or
through a mask, with the variation of the energy quantity to be applied being given in that the mask's transparency to the radiation used has a defined non-uniformity over the mask area.

The plastic that can be used may be a monomer that consolidates under the action of electromagnetic radiation, preferably UV radiation, or light in the visible spectral range. As a substrate, transparent glass plates may be used.

### DESCRIPTION OF THE DRAWINGS

FIG. 1 illustrates an exemplary embodiment to explain a first version of the invented method, in which an optically effective surface structure is generated directly as a positive profile on a lenticular screen,

FIG. 2 illustrates an exemplary embodiment to explain a second version of the invented method, in which an optically effective surface structure is also generated directly as a positive profile on a lenticular screen,

FIG. 3 illustrates an exemplary embodiment to explain a third version of the invented method, in which first a negative profile of the optically effective structure is generated and subsequently a great number of lenticular screens are molded from this negative profile.

### DETAILED DESCRIPTION OF THE DRAWINGS

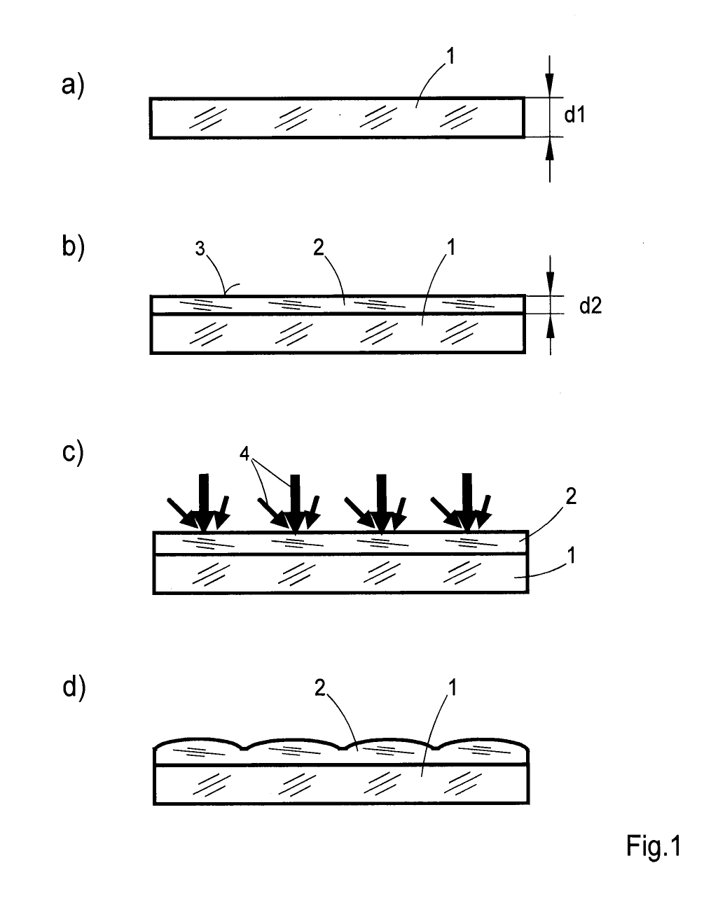

The first version of the method is shown in FIG. 1 in various stages of the process. FIG. 1 a shows a substrate 1 in the form of a transparent plate of float glass having a thickness d1 of preferably 1 mm to 3 mm.

FIG. 1b again shows the substrate 1, here already coated with a plastic layer 2 of an optically transparent monomer that is still liquid but will cure under the action of UV radiation, for example, a commercial UV-curing adhesive. Advantageously, the coating thickness d2 of the plastic layer 2 is in the range of 0.1 mm to 0.5 mm. The surface 3 of the plastic layer 2 facing away from the substrate 1 should be as smooth as possible, which is achieved, for example, by homogeneous application of the liquid monomer, or by subjecting the composite of the substrate 1 and the plastic layer 2 to vibrations or centrifugal movements.

FIG. 1c explains the application of the UV radiation indicated by the arrows 4 into the plastic layer 2. The UV radiation is applied through a suitable mask, or by means of laser radiation targeted at the positions where the greatest structure heights are desired. As shown here, this does not require the radiation to be transmitted through the substrate 1. This helps avoid losses in radiation intensity, so that relatively short exposure times can be specified or light sources of lower radiation intensity be used. Moreover, compared to the radiation being transmitted through the substrate 1, it is better possible in this manner to reduce to a tolerable level the risk of the UV light injuring the operating staff.

The polymerization initiated by the irradiation results in a curing process starting in the exposed positions of the surface 3. In the course of time, the curing proceeds from the exposed positions to the volume of the plastic layer 2.

Depending on the properties of the plastic, on the intensity and duration of the radiation exposure and on the temperature of the substrate material, the plastic and the environment, a point in time is determined at which the irradiation is ceased and the plastic portions not solidified so far are removed, e.g., by washing-off and rinsing with a solvent.

After the washing-off and rinsing, the cured plastic portions remain on the substrate 1, forming the optically effective lenticular structures, as shown in FIG. 1d. What is obtained is a lenticular screen consisting of the cured plastic layer 2 and the substrate 1.

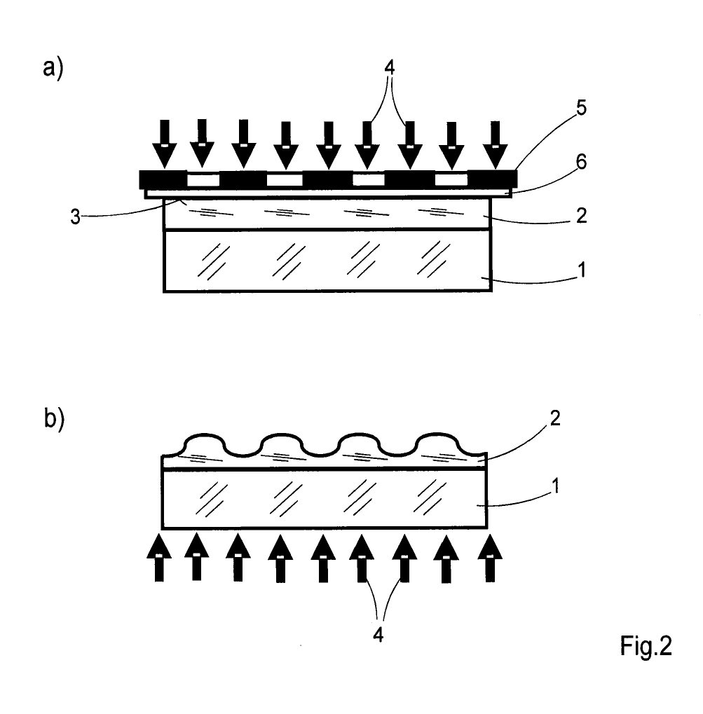

In the second version of the invented method, shown in FIG. 2, an optically effective surface structure is also generated directly as a positive profile on a plastic layer 2. FIG. 2a illustrates an example of energy input by means of an exposure mask 5; thanks to this exposure mask 5, the UV radiation, incident on the surface 3 of the plastic layer 2 that faces away from the substrate 1, hits those positions where the greatest structure heights are desired. The exposure mask 5 should favorably be separated from the—initially still completely liquid—plastic layer 2 by a separating layer, e.g., a flexible plastic foil 6. Due to the polymerization initiated by the exposure, the curing structures—at an equilibrium with the surface tension—expand into the still liquid plastic layer 2.

After the energy input from this side, the exposure mask 5 is removed, and again depending on the properties of the plastic, on the intensity and duration of the radiation exposure and on the temperature of the substrate material, the plastic and the environment, a point in time is determined at which the irradiation is ceased and the plastic portions not solidified so far are removed by washing-off and rinsing.

Subsequently, unlike in the first version, a residual energy input is effected through the substrate 1 into the plastic layer 2. This second exposure through the substrate 1 is intended to cure internal volume portions of the plastic that may still be liquid, if any.

Here again, a lenticular screen consisting of the cured plastic layer 2 and the substrate 1 is obtained.

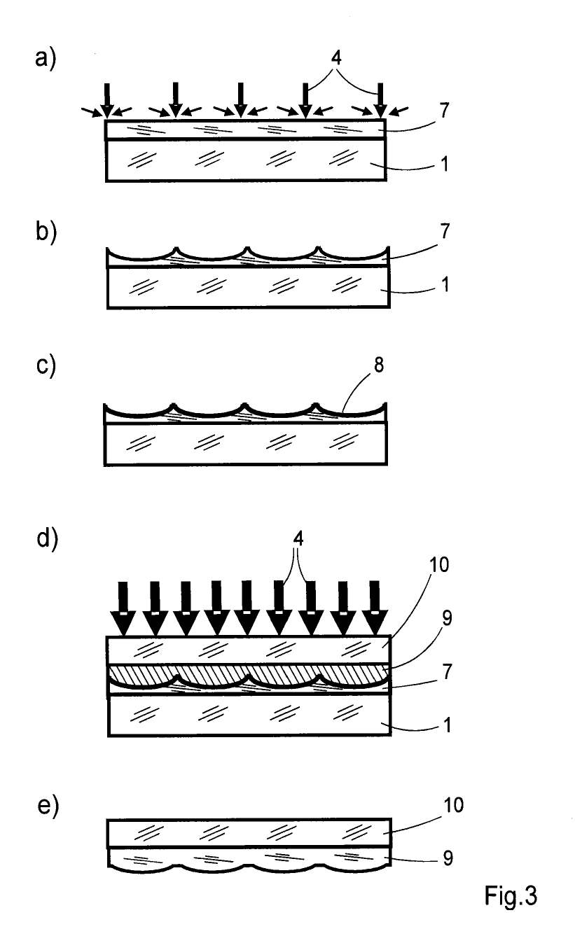

These first two versions of the method are suitable especially for the fabrication of single lenticular screens in very small batches. For large-scale or mass production, the third version of the invented method is better suited; it is explained below with reference to FIG. 3.

As shown in FIG. 3a and comparable to the process steps according to FIG. 1a through FIG. 1c, a plastic layer 7 of an—at first still completely liquid—plastic that will solidify under the influence of energy is applied onto the substrate 1, which in this case, however, need not be transparent. Preferably, this plastic may again be a monomer that will cure under UV radiation, say, a commercial UV-curing adhesive.

In this case, though, the energy input into the plastic layer 7 is controlled in such a way that, as a result of the energy input, the smallest quantities of still liquid plastic remain in positions with the smallest structure heights desired, and the greatest quantities of still liquid plastic remain in positions with the greatest structure heights desired. After the uncured plastic has been washed away, the cured plastic remains as a negative profile of the optically effective surface structure, as shown in FIG. 3b.

Next, a thin plastic foil 8 that does not distort the structure is applied onto the negative profile as a separating layer (FIG. 3c); thereafter, for the purpose of molding, the negative profile is topped up with curable, optically transparent plastic, thus creating a plastic layer 9. The plastic used here may, for example, be the same monomer as that used in the first two versions of the method.

The still liquid, optically transparent plastic is evenly distributed in the negative profile and covered with a glass pane 10, which is preferably antireflection-coated on the side facing away from the plastic in order not to lessen the intensity of the UV radiation (here also indicated by the arrows 4) when it penetrates the glass pane 10 (FIG. 3d).

After exposure and curing, the negative profile and the lenticular screen formed of the plastic layer 9 and the glass pane 10 are separated from each other. As a result of the molding, a lenticular screen (FIG. 3e) is obtained, which has been fabricated without an expensive diamond tool and without an expensive nickel mold.

As explained above, the process of solidification of the plastic can be influenced or controlled both by varying the intensity of the UV radiation and by spatially and/or temporally differentiating the application of UV radiation into the monomer, or by varying the temperature of the material and the environment.

1-9. (canceled)

10. A method for fabricating objects with a structured optically effective surface, which has, in different positions, differently specified structure heights, comprising:
selecting a liquid plastic curable by the input of energy;
applying liquid plastic in a layer onto a substrate;
inputting energy into the plastic and selectively varying said inputted energy for different positions as a function of the structure height to be produced in the different positions, whereby as a result of the energy inputted, different quantities of uncured and cured plastic are provided in different positions in the layer; and, removing the uncured plastic from the layer thereby providing the structured optically effective surface.

11. The method as claimed in claim 10, further comprising smoothing the surface of the plastic layer before inputting energy into the plastic.

12. The method as claimed in claim 10, further comprising selecting UV light as the energy.

13. The method as claimed in claim 10, further comprising placing a mask over layer of liquid plastic before inputting energy into the plastic.

14. The method as claimed in claim 10, further comprising effecting the energy input with a laser beam guided in a scanning manner with respect to the plastic.

15. A method for fabricating objects with a structured optically effective surface, which has, in different positions, differently specified structure heights, comprising:
application of a liquid plastic onto a layer on a substrate, the liquid plastic curable by inputting energy;
input of energy into the plastic layer for solidifying selected portions of the liquid plastic on the substrate for creating a negative profile of a lenticular lens; and
removing the liquid plastic that is not solidified revealing the negative profile.

16. The method of claim 15, further comprising adding a curable optically transparent plastic to the negative profile.

17. The method of claim 16, further comprising curing the curable optically transparent plastic added to the negative profile and removing the cured optically transparent plastic thereby providing a structured optically effective surface.

18. The method of claim 16, further comprising, prior to adding the curable optically transparent plastic to the negative profile, applying a separating layer to the negative profile.

19. The method of claim 18, further comprising selecting a flexible plastic foil as the separating layer.

20. The method as claimed in claim 15, further comprising providing a UV curable optically transparent plastic.

21. The method as claimed in claim 15, further comprising smoothing the surface of the plastic layer before the inputting energy into the plastic.

22. The method as claimed in claim 17, further comprising joining the optically transparent plastic added to the negative profile to a transparent substrate.

23. The method as claimed in claim 22, further comprising joining optically transparent plastic added to the negative profile to a transparent substrate after the optically transparent plastic has cured.

24. A method as claimed in claim 10, further comprising selecting as the liquid plastic used is a monomer that solidifies under the influence of at least one of UV or IR radiation.

25. A method as claimed in claim 15, further comprising selecting as the liquid plastic used is a monomer that solidifies under the influence of at least one of UV or IR radiation.

26. A method as claimed in claim 10, further comprising combining the structured optically effective surface with an LC display for the purpose of permitting 3D vision of the images presented on the LC display without further aids such as 3D glasses.

27. A method as claimed in claim 10, further comprising combining the structured optically effective surface with an LC display for the purpose of permitting 3D vision of the images presented on the LC display without further aids such as 3D glasses.

28. A method for fabricating objects with a structured optically effective surface, which has, in different positions, differently specified structure heights, comprising:
selecting a liquid plastic curable by the input of at least one of UV and IR energy;
applying liquid plastic in a layer onto a substrate;
smoothing the layer of liquid plastic;
inputting one of UV and IR energy into the plastic and selectively varying said inputted energy for different positions as a function of the structure height to be produced in the different positions, whereby as a result of the energy inputted, different quantities of uncured and cured plastic are provided in different positions in the layer; and
removing the uncured plastic from the layer providing a structured surface.

29. A method as claimed in claim 10, further comprising varying the inputted energy for different positions by at least one of a scanning laser and a mask.
